(19) United States
(12) Patent Application Publication
(10) Pub. No.: US 2012/0021218 A1
(43) Pub. Date: Jan. 26, 2012

(54) ELECTRICALLY CONDUCTIVE METAL-COATED FIBERS, CONTINUOUS PROCESS FOR PREPARATION THEREOF, AND USE THEREOF

(75) Inventors: Jar-Wha Lee, Columbus, OH (US); Ching Chang, Gahanna, OH (US)

(73) Assignee: SYSCOM ADVANCED MATERIALS, INC., Columbus, OH (US)

(21) Appl. No.: 13/187,927

(22) Filed: Jul. 21, 2011

Related U.S. Application Data
(60) Provisional application No. 61/367,235, filed on Jul. 23, 2010.

(51) Int. Cl. D02G 3/36; C25D 5/34; B05D 5/00; C23C 28/02; B05D 3/10; B05D 1/00; C25D 5/54; C25D 7/00

(52) U.S. Cl. 428/395; 205/159; 427/304; 427/306

(57) ABSTRACT

In various embodiments, the present application provides electrically conductive metal-plated fibers and continuous processes of preparing metal-plated fibers. Additionally, provided are polymeric articles comprising the provided metal-plated fibers or other fibers prepared by the provided process, said articles having electromagnetic interference shielding effectiveness.

### CROSS REFERENCE TO RELATED APPLICATIONS

This application claims priority under 35 U.S.C. §119(e) to U.S. Provisional Patent Application Ser. No. 61/367,235, filed on Jul. 23, 2010, the entirety of which is hereby incorporated.

### BACKGROUND

Electrical wires are typically made of highly conductive metals, such as copper. These metals afford the highest electrical conductivity for signal and power transfer, and can also be used for electromagnetic interference (EMI) shielding applications. However, the weight of metal wires (e.g., copper has a density of 8.96 g cm⁻³) is undesirable for applications where weight savings are important. Examples of such applications include, but are not limited to, aerospace applications. Some known efforts to reduce the weight of electrical wiring systems have involved replacing standard gauge copper wire (eg., 22 gauge) with a smaller gauge wire (e.g., 26 or 28 gauge). However, because thinner wires do not have the necessary mechanical strength and durability required for many applications, replacing the gauge of wiring is typically not a feasible solution to the problem. Additionally, in applications where durability and flexibility are essential, the rigidity and fatigue characteristic of metal wires are problematic.

Electrically conductive metal-coated polymer fibers have been proposed as a solution to the need in the art for improved conductive materials. Metal-coated fibers are typically made by metallizing polyp-phenylene benzobisoxazole) (Zylon®) or polyp-phenylene terephthalamide) (Kevlar®) fiber with highly conductive metals. Because the interior fiber has a high tensile strength and Young's modulus, low density, and small diameter, such metal-coated polymer fibers offer benefits over traditional conductive wires (such as copper wires) in flexibility, weight savings, and durability. Nevertheless, there is unmet need in the art for additional metal-coated fibers, particularly those that provide long-term fiber strength and stability and can be used in applications where durability and flexibility are essential. One example of such an application is EMI shielding. Braided EMI shields are traditionally made from standard copper wire, but utilizing metal-clad fibers instead provides weight savings and can provide better shielding at high frequencies due to increased braid coverage and less windowing.

In addition to some types of metal-clad fibers being known, some processes for their preparation are also known. For example, U.S. Pat. No. 7,166,354 discloses a batch process to metallize polyester fiber. However, it is evident that treatment conditions appropriate in a batch process are not necessarily suitable for a continuous process. For example, treatment conditions of a batch process may not achieve a surface structure having maximum metal to fiber adhesive strength, desired metal coating thickness and uniformity, and minimum fiber strength degradation. Additionally, treatment conditions of a batch process may not provide quality consistency over a long length of fiber. Thus, there remains unmet needs in the art for improved methods of preparing metal-coated fibers.

### SUMMARY

These needs are met by the present application, which provides in various embodiments, electrically conductive metal-plated fibers and continuous processes of preparing metal-plated fibers. Additionally, provided are polymeric articles comprising the provided metal-plated fibers, said articles having electromagnetic interference shielding effectiveness.

In some embodiments, provided are metal-plated liquid crystalline polymer fibers, comprising (a) a melt processable, thermotropic wholly aromatic liquid crystalline polymer fiber; (b) at least one coating of electroless-plated metal on said fiber; and (c) optionally, at least one coating of electroplated metal on said fiber. In some embodiments, the wholly aromatic liquid crystalline polymer fiber is a polyester consisting essentially of repeating units of (I) and (II):

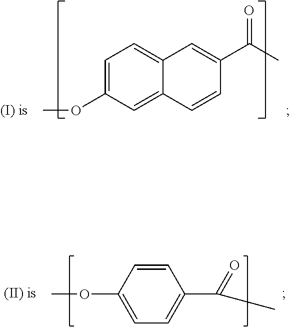

In some embodiments, the wholly aromatic liquid crystalline polymer fiber is selected from Vectran® fiber, Ekonol® fiber, and Xydar® fiber, and may be monofilament fiber or multi-filament fiber.

Also provided is a continuous process for introducing electrical conductivity to high-temperature, high-strength aromatic fibers by forming well-adhered uniform metal layers on such fibers. In some embodiments, the provided process comprises (a) etching the surface of a melt processable wholly aromatic liquid crystalline polymer fiber by contacting it with alkaline solution in the presence of ultrasonic agitation, wherein the alkaline solution does not comprise surfactant or solubilizer; (b) seeding the etched surface with catalyst by contacting the etched fiber with one or more electroless plating catalysts; (c) reducing the catalyst by contacting said fiber with a reducing solution; (d) electrolessly plating at least one coating of metal on said fiber; and (e) optionally, electroplating at least one coating of metal on said fiber. Metal-plated fibers prepared by the provided process show one or more of thermal stability, thermo-oxidative stability, mechanical flexibility, durability, strength, electrical conductivity, small diameter, and light weight.

In some embodiments, further provided is a polymeric article having electromagnetic interference shielding effectiveness, the article comprising a provided metal-plated fiber or other fiber prepared by the provided process. Accordingly, in some embodiments, the provided article comprises: (a) a melt processable, thermotropic wholly aromatic liquid crystalline polymer fiber; (b) at least one coating of electroless-plated metal on said fiber; and (c) optionally, at least one coating of electroplated metal on said fiber; wherein the fiber of (b) or (c) is adapted to be woven or braided to provide a polymeric article having electromagnetic interference shielding effectiveness.

These and additional embodiments of the present application will become apparent in the course of the following detailed description.

### BRIEF DESCRIPTION OF THE DRAWINGS

A more complete appreciation of the invention and the many embodiments thereof will be readily obtained as the same becomes better understood by reference to the following detailed description when considered in connection with the accompanying drawings, wherein:

FIG. 1 illustrates the chemical structure of one example (Vectran® fiber) of a wholly aromatic polyester liquid crystalline fiber (wherein x and y are variable) that may be used in the provided process to prepare a provided metal-plated fiber, a provided polymeric article having EMI shielding effectiveness, or combinations thereof;

FIG. 2 depicts a schematic drawing of a cross-section of one example of a metal-coated monofilament that may be prepared according to the provided process;

FIG. 3 depicts a schematic of one embodiment of a continuous process of producing metal-coated fibers, wherein in some embodiments, one or more optional rollers, ultrasonic agitation, tension control (for example, below 50 g), and combinations thereof are employed in at least the surface modification step. In some embodiments, the fiber may be continuously transferred from bath to bath utilizing one or more rollers, wherein tension control is achieved by adjusting fiber transfer speed between each bath. In some embodiments, de-ionized water rinsing between chemical baths may be used to remove any cross-contamination; and

FIG. 4 depicts a schematic of metallization of a bundle of monofilaments by the provided process.

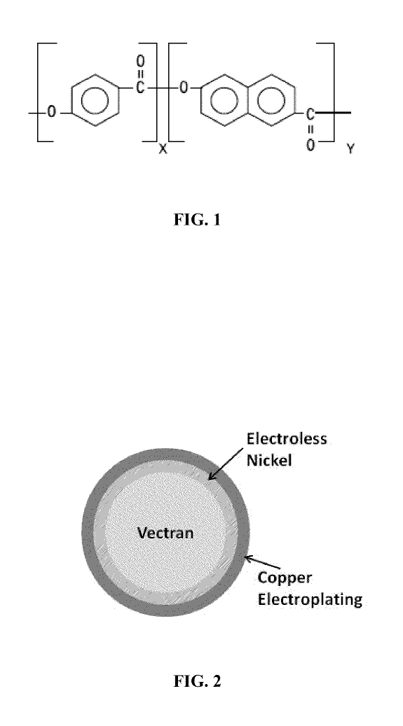

### DETAILED DESCRIPTION

Specific embodiments of the present invention will now be described. The invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the specification and appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Additionally, the disclosure of any ranges in the specification and claims are to be understood as including the range itself and also anything subsumed therein, as well as endpoints. Unless otherwise indicated, the numerical properties set forth in the specification and claims are approximations that may vary depending on the desired properties sought to be obtained in embodiments of the present invention. Notwithstanding that numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

### I. Electrically Conductive Metal-Coated Fibers

In various embodiments, provided are electrically conductive metal-plated high-temperature aromatic polymer fibers comprising (a) at least one coating of electroless-plated metal on the fiber and (b) optionally, at least one coating of electroplated metal. Said fibers are, in some embodiments, prepared by the provided continuous fabrication process comprising depositing one or more uniform layers of metals onto fibers through one or more of electroless and electroplating methods.

Deposited electroless-plated metals may, in some embodiments, be selected from nickel, copper, silver, and alloys thereof. In some embodiments, the provided fibers comprise at least one coating of electroless-plated nickel/phosphorous alloy. Deposited electroplated metals may, in some embodiments, be selected from tin, nickel, copper, silver, gold, and alloys thereof. Whether deposited by electroless plating or electroplating methods, metals may be deposited in one, two, three, four, or more layers, each layer being of a metal that is the same as or different from the previous layer. In some embodiments, the deposited metal layers may have a cumulative thickness of from about 1 μm to about 10 μm. Accordingly, the cumulative thickness of the deposited metal layers may be 1 μm, 2 μm, 3 μm, 4 μm, 5 μm, 6 μm, 7 μm, 8 μm, 9 μm, 10 μm, or combinations thereof. In some embodiments, the fibers coated by the metal(s) are liquid crystalline polymer fibers. In some embodiments, the fibers are melt processable, thermotropic wholly aromatic liquid crystalline polymer fibers. Examples include, but are not limited to, Vectran® fiber (Kuraray), Ekonol® fiber (Saint-Gobain), and Xydar® fiber (Solvay). Good results have been achieved with Vectran fiber. However, it is contemplated that the process may be used on other types of high temperature aromatic fibers, such as Zylon® (PBO) fiber and Kevlar® (aramid) fiber, PEEK (polyether ether ketone) fiber, Ultem® (polyetherimide) fiber, and PPS (polyphenylene sulfide) fiber to produce metal-plated fibers.

In various embodiments, wholly aromatic polyester liquid crystalline fibers may be used in the provided process to form metal-plated fibers. Wholly aromatic polyester liquid crystalline polymers are known in the art, and many are commercially available. Examples include, but are not limited to, those comprising moieties derived from one or more of 6-hydroxy-2-naphthoic acid; 4,4′-biphenol; hydroquinone; p-hydroxybenzoic acid; terephthalic acid; isophthalic acid; and ring-substituted derivatives thereof. In some embodiments, suitable wholly aromatic liquid crystalline polymer fibers are melt processable, thermotropic polyesters of 2,6-dicarboxynaphthalene and p-oxybenzoyl moieties, or ring-substituted derivatives thereof. Accordingly, suitable fibers for use in the provided process to form metallized fibers consist essentially of repeating units of (I) and (II):

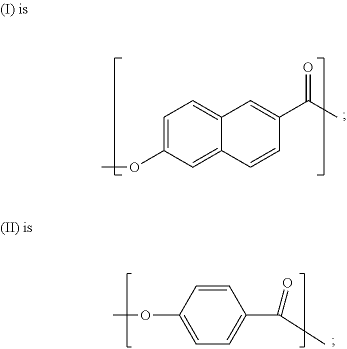

wherein at least one hydrogen of an aromatic ring of (I), (II), or both, may optionally be substituted with an alkyl group, an alkoxy group, a halogen, or combinations thereof.

For purposes of illustrating embodiments, Vectran fiber and uses thereof to form metallized fibers, including by the provided process, will be described. However, the scope of this present application is not intended to be limited by such illustration. Rather, the scope is intended to encompass other high temperature aromatic polymers, including without limitation, other wholly aromatic polyester liquid crystalline fibers.

Vectran fiber is a highly oriented multi-filament polyester-polyarylate liquid crystalline polymer fiber exhibiting a very high tensile strength and high melting temperature. Vectran fiber is three to five times stronger than other polyesters and is stronger than aramid fibers (Kevlar). In addition to having high strength, Vectran fiber has excellent rigidity, tenacity retention, abrasion resistance, moisture resistance, and property retention over a broad range of temperatures and chemical environments. Some properties of Vectran fiber, as compared to other high strength fibers, are illustrated in Tables 1-3.

TABLE 1

| | | | | | Elong./ | |
|---|---|---|---|---|---|---|
| | Strength | Modulus | Density | Moisture | Break | Max T |
| Fiber | (GPa) | (GPa) | (g/cm³) | (%) | (%) | (° C.) |
| Spectra ® | 3 | 171 | .97 | — | 2.7-3.3 | 100 |
| 1000 | | | | | | |
| (HMPE) | | | | | | |
| Vectran ® | 3.2 | 91 | 1.47 | 0.1 | 3.3 | 150 |
| Kevlar ® | 2.9 | 135 | 1.45 | 3-4 | 2.8 | 250 |
| 49 | | | | | | |
| Stainless | 7.6 | 150 | 7.8 | — | 4.8 | 500 |
| steel | | | | | | |

Source: Fette & Sovinski, “Vectran Fiber Time-Dependent Behavior and Additional Static Loading Properties,” NASA/TM-2001-212773, National Aeronautics and Space Administration, 2004.

TABLE 2

| | | | | Abrasion | | | |
|---|---|---|---|---|---|---|---|
| | | % | Melting | Resistance | | Stress | Thermal |
| | Tenacity | Tenacity | Point | (Cycle | Creep | Relaxation | Conductivity |
| Fiber | (GPa) | at 150° C. | (° C.) | ratio) | [%/Log(t)] | [%/Log(t)] | [W/(m × K)] |
| Vectran ® | 2.9 | 55 | 330 | 10 | 0.0003 | 0.033 | 0.37 |
| Kevlar ® | 3.0 | 81 | Chars | 1 | 0.0015 | 0.015 | 0.04 |
| 49 | | | | | | | |

Source: Fette & Sovinski, “Vectran Fiber Time-Dependent Behavior and Additional Static Loading Properties,” NASA/TM-2001-212773, National Aeronautics and Space Administration, 2004.

TABLE 3

| | Tensile | Tensile | | Specific |
|---|---|---|---|---|
| | Strength | Modulus | Density | Strength/Breaking |
| Fiber | (GPa) | (GPa) | (g/cm³) | Length (km) |
| Vectran ® NT | 1.1 | 52 | 1.4 | 79 |
| Vectran ® HT | 3.2 | 75 | 1.41 | 229 |
| Vectran ® UM | 3.0 | 103 | 1.4 | 215 |
| Titanium | 1.3 | 110 | 4.5 | 29 |
| Stainless | 2.0 | 210 | 7.9 | 26 |
| Steel | | | | |
| Aluminum | 0.6 | 70 | 2.8 | 22 |
| E-Glass | 3.4 | 72 | 2.6 | 130 |
| Graphite | 4.3 | 230 | 1.8 | 240 |

Source: “Vectran, Grasp the World of Tomorrow,” Kuraray America, Inc., 2006.

Vectran fiber is different from other high strength fibers, such as aramid fiber, poly(p-phenylene-2,6-benzobisoxazole) (PBO) fiber, and ultra-high molecular weight polyethylene (HMPE) fiber. Aramid fiber (Kevlar®, DuPont) and PBO fiber (Zylon®, Toyobo) are solvent-spun fibers, and HMPE fiber (Spectra®, Honeywell) is gel-spun. In contrast to such fibers, Vectran fiber is a thermotropic liquid crystalline polymer formed by melt-spinning through fine diameter capillaries, a process causing molecular chains to orient parallel to the fiber axis without chain folding. By comparison, the molecular chains of conventional polyesters are random and flexible and have chain folding. Vectran fiber is hydrophobic, resistant to hydrolytic degradation, and shows good tenacity retention in aggressive chemical exposure. Because the moisture absorbed by a fiber during the original manufacturing or metallization processes will remain with the fiber after metallization, hydrolytic stability of fibers is important for long-term stability, especially when the metallized fiber will be used at elevated temperatures. Vectran fiber has higher hydrolytic stability than other fibers, including Kevlar® and Zylon® fibers. Additionally, it has been reported that the tenacity retention of Vectran fiber is far superior to standard Aramid fiber, like Kevlar, after 300 hours thermal exposure at 250° C.

The highly conductive metal-coated polymer fibers prepared by the provided process have advantages over copper wires in terms of flexibility, light weight, strength, durability, and tailored electrical/mechanical properties. The provided metal-plated fibers also have advantages over other metal-coated fibers. For example, provided metal-coated polymers may have higher long-term hydrolytic stability, higher temperature capability, higher conductivity, or combinations thereof, with respect to metallized Kevlar, metallized Zylon, and other metallized fibers. Moreover, it is contemplated that metallized fibers such as Vectran may be used in applications such as EMI shielding. For example, metal-plated Vectran may be woven or braided into a polymeric article having EMI shielding effectiveness.

While wholly aromatic polyester liquid crystalline polymer fibers such as Vectran may be attractive substrates for metallization, there are challenges to metallizing such fibers. Vectran fiber is unique with respect to its formation and its properties, and such uniqueness presents challenges to its use in applications. The fiber is hydrophobic, exhibits high bundle stiffness, is sensitive to static, has thermoplastic properties, and it has a multi-layered fiber structure, all of which create unique challenges to processes of metallization. Thus, known processes for metallization of polymer fibers are not suitable for metallization of fibers such as Vectran® fibers

### II. Continuous Process for Preparation of Electrically Conductive Metal-Coated Fibers

In various embodiments, provided is a continuous process for introducing electrical conductivity to high-temperature aromatic polymer fibers. Examples of fibers contemplated to be suitable for use in the provided process include, but are not limited to, PEEK (polyether ether ketone) fiber; Ultem® (polyetherimide) fiber; PPS (polyphenylene sulfide) fiber; and melt processable, thermotropic wholly aromatic liquid crystalline polymer fibers.

In various embodiments, the continuous process of metallizing aromatic polymer fibers comprises (a) surface modification (b) catalyzing, (c) reduction, (d) electroless plating of metal, and (e) optionally, electroplating metal. In some embodiments, the metal-plated fiber comprises one or more coatings of electrolessly-plated metal, each coating being of the same or different metal as the prior coating. In some embodiments, the metal-plated fiber further comprises one or more coatings of electroplated metal, each coating being of the same or different metal as the prior coating. The electrical conductivity of the resulting metal-coated fiber can be tuned over a very wide range depending on the plating thickness and composition of the metal coating. As one example, resistance of a metal-coated fiber may range from about 0.5 to about 300 Ohm per foot. Accordingly, resistance can be from 0.5-1, 1-5, 5-10, 10-20, 20-30, 30-40, 40-50, 50-60, 60-70, 70-80, 80-90, 90-100, 100-110, 110-120, 120-130, 130-140, 140-150, 150-160, 160-170, 170-180, 180-190, 190-200, 200-210, 210-220, 220-230, 230-240, 240-250, 250-260, 260-270, 270-280, 280-290, 290-300 Ohms per foot, and combinations thereof. With the provided process, a yarn of polymeric fiber (whether a monofilament or multifilament tow) can be made highly conductive in a single continuous reel-to-reel method.

The provided process allows highly conductive metals to be incorporated onto a polymer fiber, giving rise to electrical conductivity. The goal is to produce a light weight, mechanically robust material that contains a desired volume fraction of metal but has a metallic conductivity comparable to current state-of-the-art high strength copper alloy, such as CS-95 alloys. In the provided process, one or more highly conductive metals are deposited onto polymer fibers by an autocatalytic deposition process, commonly referred to as “electroless plating.” The autocatalytic deposition process allows for uniform deposition of metal onto catalyzed surfaces of objects that are immersed in a solution. The electroless plating process occurs without application of an electrical current. Instead, deposition occurs through a controlled electrochemical reduction process. Various conductive metals can be deposited. In some embodiments, one or more of copper, nickel, silver, gold, and alloys thereof, may be deposited by the provided process. In some embodiments, one or more layers of metal may be deposited (via electroplating techniques) onto the electrolessly-plated metal coating(s).

In various embodiments, the provided process may be applied to wholly aromatic polyester liquid crystalline fibers (including, but not limited to Vectran® fibers) in order to produce metal-plated liquid crystalline polymer fibers. Accordingly, in some embodiments provided is a continuous process for preparing metal-plated liquid crystalline polymer fibers, comprising (a) etching the surface of a melt processable, thermotropic wholly aromatic liquid crystalline polymer fiber by contacting it with alkaline solution in the presence of ultrasonic agitation, wherein the alkaline solution does not comprise surfactant or solubilizer; (b) contacting the fiber of (a) with one or more electroless plating catalysts selected from salts of silver, nickel, gold, platinum, osmium, palladium, and rhodium; (c) contacting the fiber of (b) with a reducing solution; (d) electrolessly plating at least one coating of metal on the fiber of (c), the electroless-plated metal selected from nickel, copper, silver, and alloys thereof; and (e) optionally, electroplating at least one coating of metal on the fiber of (d), the electroplated metal selected from tin, nickel, copper, silver, gold, and alloys thereof.

In some embodiments, suitable fibers for use in the provided process consist essentially of repeating units of (I) and (II):

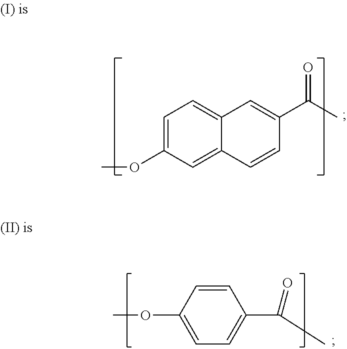

wherein at least one hydrogen of an aromatic ring of (I), (II), or both, may optionally be substituted with an alkyl group, an alkoxy group, a halogen, or combinations thereof. One commercial example of such fiber is Vectran® fiber.

For purposes of illustration, but not limitation, the process will be described with respect to metallization of Vectran® fibers. However, one of skill in the art will recognize that alternative fibers (whether monofilament or multi-filament) may also be metallized by the provided process.

### (a) Surface Modification

The purpose of surface modification is to provide some interlocking mechanism on the Vectran® fiber for chemical and/or physical bonding with the subsequently applied electroless metal plating. Vectran® fiber is a thermotropic liquid crystalline polymer fiber which provides excellent resistance to a wide range of organic and inorganic chemicals. Conventional processes (such as those described in U.S. Pat. Nos. 5,302,415; 5,422,142; 5,453,299; 5,935,706; and 6,045,680) to uniformly metallize multiple-filament polymeric fibers of polyaramid, polyamide, or polyester involve strong acid surface preconditioning (often in combination with surfactant to help the acid to penetrate fiber bundles) followed by electroless nickel coating. However, such processes do not work on Vectran® fiber, which is damaged by highly concentrated acids, and the treated fiber cannot be wetted effectively to accept subsequent seeding of the catalyst and initiation of the electroless plating step. For example, attempts to use highly concentrated sulfuric acid (90-98 wt %) to modify fiber surface were not successful. Furthermore, it was observed that the conventional process of using potassium permanganate in concentrated sulfuric acid is also ineffective in roughening and wetting the surface of Vectran® fibers in a manner suitable for continuous production.

U.S. Pat. Nos. 6,403,211 and 6,923,919 disclose a process of how to effectively etch a liquid crystalline polymer film with a heated potassium hydroxide (KOH) bath with ethanolamine solubilizer. In addition, they describe that a LCP film is preconditioned insufficiently by KOH solution alone. It was unexpectedly observed, however, that the methods described with respect LCP films are not applicable to LCP fibers. In contrast to the described processes for etching a LCP film, the provided process allows for successful modification of Vectran® fiber surfaces with a heated alkaline solution alone (i.e., without any solubilizer or surfactant). It was observed that, at least with respect to Vectran® fibers, ultrasonic agitation was unexpectedly required to be used to facilitate proper etching. This suggests that ultrasonic agitation operates in the provided process in a manner other than its conventional purpose, which is to merely clean a fiber surface. Without being bound by theory, it is contemplated that because Vectran® fiber is highly stretched during its manufacturing processing, significant changes in fiber surface structure morphology, molecular weight, crystallinity, and melting point are introduced, and that such changes give rise to significant differences, especially on the material surface, between the properties of a LCP film and those of a LCP fiber. Due to such differences, what is known about treating LCP films is not applicable to treating LCP fibers.

The provided process comprises contacting the fiber with alkaline solution. The alkaline solution may be one or more of a strong base, including but not limited to, bases such as lithium hydroxide (LiOH), sodium hydroxide (NaOH), potassium hydroxide (KOH), rubidium hydroxide (RbOH), cesium hydroxide (CsOH), calcium hydroxide (Ca(OH)2), strontium hydroxide (Sr(OH)2), barium chloride (Ba(OH)2). Good results have been achieved with KOH. However, it was observed that excess alkaline solution etching of Vectran® fibers not only significantly damages the strength of the fiber but also removes the delicate etched surface morphology that helps to promote the metal-to-polymer adhesive property. Thus, in order not to significantly alter the core mechanical integrity of the fiber and its etched surface structure, one or more of the chemical solvent, the solution concentration, and the solution processing temperature may be selected to provide the desired characteristics.

Good results have been obtained by etching Vectran® fibers in an aqueous solution of KOH at a temperature of from about 40° C. to 100° C. Thus, temperature may be from about 40° C.-45° C., 45° C.-50° C., 50° C.-55° C., 55° C.-60° C., 60° C.-65° C., 65° C.-70° C., 70° C.-75° C., 75° C.-80° C., 80° C.-85° C., 85° C.-90° C., 90° C.-95° C., 95° C.-100° C., and combinations thereof. In some embodiments, the temperature may be from about 45° C. to 65° C.; alternatively, from about 55° C. to 65° C.; alternatively, from about 50° C. to 80° C.; alternatively, from about 80° C. to 100° C. In some embodiments, the KOH solution has a concentration of from about 20 wt % to about 75 wt %, wherein the concentration is selected to avoid extensive fiber damage. Thus, concentration may be from 20-25 wt %, 25-30 wt %, 30-35 wt %, 35-40 wt %, 40-45 wt %, 45-50 wt %, 50-55 wt %, 55-60 wt %, 60-65 wt %, 65-70 wt %, 70-75 wt %, and combinations thereof. In some embodiments, the concentration may be from about 30 wt % to about 45 wt %. In some embodiments, the concentration may be from about 45 wt % to about 60 wt %. It has been observed that if the KOH solution concentration and temperature drop below 30 wt % and 50° C., respectively, the Vectran® fiber surface is not sufficiently wetted to effectively accept the subsequently applied catalyst in a timely manner. However, it has also been observed that fiber strength starts to decrease when KOH solution concentration and temperature are above 30 wt % and 50° C., respectively. Moreover, due to the small diameter of Vectran® monofilaments, surface modification as little as one micron deep will result in 16% loss of the whole fiber strength. Therefore, it is important that etching conditions be selected such that the KOH solution can etch each filament effectively and uniformly in as short a period of time as possible. In some embodiments, KOH etching should occur simultaneously with ultrasonic agitation. Vectran fiber is available in 5, 20, 40, 80 and higher monofilament tows, and the provided processes may be used on the same to provide metal-clad Vectran fibers having a variable number of monofilaments. Good results have been obtained by etching a 40 monofilament tow of Vectran® fiber, while simultaneously providing ultrasonic agitation at 25-120 KHz, for a period of from about 10 seconds to about 200 seconds. In some embodiments, agitation may be from about 25-45 KHz; alternatively, from about 45-65 KHz; alternatively, from about 65-85 KHz; alternatively, from about 85-105 KHz; alternatively, from about 105-120 KHz. In some embodiments, the period of time may be from about 50 to 100 seconds; alternatively, from about 100 to 200 seconds; alternatively, from about 10 to 50 seconds.

In some embodiments, a favorable KOH solution etching environment may be achieved with the combination of mechanical agitation arising due to continuous movement of yarn monofilaments during operation of the continuous process with additional agitation created by ultrasound. Without being bound by theory, it is believed that the enormous surface disruption upon cavitation under ultrasonic agitation and the repeated mechanical rubbing among the continuously moving filaments result in a surface adapted for accepting catalyst. This is evidenced by observations that approximately 100% of a treated Vectran® surface may be metallized by the combination of the KOH etching and ultrasound agitation, whereas only 80 to 90% surface metallization occurred when no ultrasonic agitation was used.

In some embodiments, one or more optional rollers may be used to aid in the surface modification of the Vectran® fiber. In some embodiments, the rollers may be selected from cylindrical and non-cylindrical rollers. For example, a non-cylindrical roller may have a transverse cross-section having a triangular, hexagonal, octagonal, or other suitable shape adapted to, when in operation, provide alternating levels of tension on yarn. As another example, one or more rollers such as those described in US2008/0280045 A1 may be used in some embodiments. The one or more rollers may be used to continuously transfer the Vectran® fiber from one chemical bath to another chemical bath, from a chemical bath to a rinse bath, from a rinse bath to chemical bath, and combinations thereof, which provides mechanical agitation to open up the fiber tow for better solution penetration.

In some embodiments, it may be necessary to control tension of the continuously moving Vectran® fiber in order to achieve the desired surface modification. For example, it may be necessary to maintain tension at or below 50 g. For example, tension may be from about 0-5 g, 5-10 g, 10-15 g, 15-20 g, 20-25 g, 25-30 g, 30-35 g, 35-40 g, 40-45 g, 45-50 g, and combinations thereof. In some embodiments, tension control of the continuously moving Vectran® fiber may be achieved by adjusting transfer speed between each bath.

### (b) Catalyzing

The catalysis process comprises seeding a catalyst onto the Vectran® fiber surface to initiate the electroless plating process. For purposes of illustration, palladium (Pd) catalyst will be discussed. However, one of skill in the art will recognize that other catalysts may alternatively be used. For example, it is contemplated that suitable catalysts may be selected from salts of silver, nickel, gold, platinum, osmium, palladium, and rhodium. Under a conventional electroless plating process, the fiber substrate is immersed in a mixed acidic colloidal solution of stannous chloride (SnCl₂) sensitizer and palladium chloride (PdCl₂) catalyst. In the colloidal solution, the Sn(II) will be oxidized to Sn(IV) while the Pd(II) will be reduced back to Pd, and the Pd nucleus will be readily absorbed onto the fiber surface as the working catalyst. Despite the mixed colloidal solution's increasing popularity with most persons of skill in the art, the initial nucleation sites generated by a separate Sn—Pd process may be as much as an order of magnitude more numerous than those produced by the mixed Sn—Pd approach. Generally, the higher the number of nucleation sites, the better the metal-to-substrate adhesive properties. Thus, in the provided process, the etched fiber is immersed in a dilute catalyst solution for a sufficient period of time to allow the catalyst to migrate and penetrate into the etched fiber structure. In some embodiments, the catalyst solution is a palladium chloride (PdCl₂)/hydrochloric acid (HCl) solution and the Pd ions migrate and penetrate into the etched fiber structure. In some embodiments, a suitable period for immersion may be from about 1-360 minutes. Accordingly, immersion may be from about 1-30 seconds, 30-60 seconds, 60-90 seconds, 90-120 seconds, 120-150 seconds, 150-180 seconds, 180-210 seconds, 210-240 seconds, 240-270 seconds, 270-300 seconds, 300-330 seconds, 330-360 seconds, and combinations thereof. In some embodiments, immersion may be from 2-3 minutes, 3-4 minutes, 4-5 minutes, and combinations thereof. In some embodiments, the acid/catalyst solution may comprise from about 0.01 to 0.5 g/L of catalyst. Thus, the catalyst concentration may be from about 0.01-0.05 g/L, 0.05-0.10 g/L, 0.10-0.15 g/L, 0.15-0.20 g/L, 0.20-0.25 g/L, 0.25-0.30 g/L, 0.30-0.35 g/L, 0.35-0.40 g/L, 0.40-0.45 g/L, 0.45-0.50 g/L, and combinations thereof. Good results have been obtained with a catalyst concentration of from about 0.1 to 0.3 g/L.

In some embodiments, the acid/catalyst solution may also comprise one or more surfactants (e.g., sodium lauryl sulfate or ammonia lauryl sulfate) to facilitate catalyst absorption onto the fiber surface. One of skill in the art will recognize that catalysts other than Pd may be utilized and that concentrations of catalyst in the acid/catalyst solution and period of immersion may be varied to accommodate different properties and characteristics of the specific catalyst chosen.

### (c) Reducing

After the fiber is immersed in the acid/catalyst solution for a suitable period of time to allow the catalyst ion to migrate and penetrate the fiber bundle, such catalysts ions (e.g., Pd ions) are then reduced in situ by immersion for a suitable period of time in a separate reducing solution, such as a sodium borohydride solution or dimethylamine borane solution. In some embodiments, the reducing solution comprises from about 0.01 wt % to about 0.10 wt % of reducing agent. Thus, the reducing agent concentration may be from about 0.01-0.05 wt %, 0.05-0.10 wt %, and combinations thereof. Good results have been obtained using a reducing agent concentration of from about 0.02 to 0.03 wt %. In some embodiments, immersion may be less than 60 seconds. For example, immersion may be from about 15-60 seconds. Good results have been obtained when immersion is less than 30 seconds. One of skill in the art will recognize that reducing agents other than sodium borohydride and dimethylamine borane may be utilized and that concentrations of reducing agent in the reducing solution and period of immersion may be varied to accommodate different properties and characteristics of the specific reducing agent chosen.

### (d) Electroless Plating

Electroless plating is an autocatalytic deposition process that places metal onto objects that are immersed in a plating solution, wherein a uniform metallic coating is deposited conformably onto catalytic surfaces under a controlled electrochemical reduction process without applying an electrical current. Electroless plating is, in a general manner, well known. However, challenges nevertheless remain, such as obtaining good adhesion of the plated metal to the fiber surface.

The provided process achieves good adhesion of metal, in part, through the choice of plating alloy. For example, a nickel sulfate based-electroless nickel solution (8 to 10 wt % Phosphorus content) may be used for nickel metallization. Such a plating solution is capable of depositing a 20 micron nickel coating onto a catalyzed Vectran® fiber at 88° C. in one hour. The suitability of nickel-phosphorus alloy coatings was surprising given the prior art teachings regarding electroless plating of fibers. For example, U.S. Pat. No. 5,935,706 and U.S. Pat. No. 6,045,680 teach against use of nickel-phosphorus alloys to coat fibers.

In practice of the provided process, nickel-phosphorus alloys may be deposited. However, it is also contemplated that metals and metal alloys other than nickel may also be deposited by electroless plating. Examples include copper, silver and alloys thereof. In some embodiments, more than one layer of metal may be deposited by electroless plating.

In some embodiments, electroless plating techniques are used to provide a uniform metal coating over the fiber surface. For example, a uniform metal coating may be greater than 85% of the fiber surface area. Accordingly, the coating may be 85%, 86%, 87%, 88%, 89%, 90%, 91%, 92%, 93%, 94%, 95%, 96%, 97%, 98%, 99%, 100%, or combinations thereof, of the fiber surface area. In the provided process, the deposited metal coats the fiber. It does not, however, form a matrix in which the fiber is embedded or encased within metal and functions to reinforce the metal matrix.

### (e) Optional Electroplating

As the fibers become electrically conductive after electroless plating (e.g., after deposition of a nickel coating), one or more additional coatings of conductive metal, such as tin, nickel, copper, silver or gold, may optionally be deposited via traditional electroplating techniques. Accordingly, in some embodiments, the provided process comprises preparing metal-plated polymer fibers with electroplated metal. In some embodiments, the provided process comprises preparing metal-plated polymer fibers without electroplated metal.

In some embodiments, a fiber having a uniform coating of electroplated metals may be achieved by, among other things, controlling voltage during the electroplating process.

After the step of optional electroplating, the resulting metal-plated fiber may be further processes by known methods.

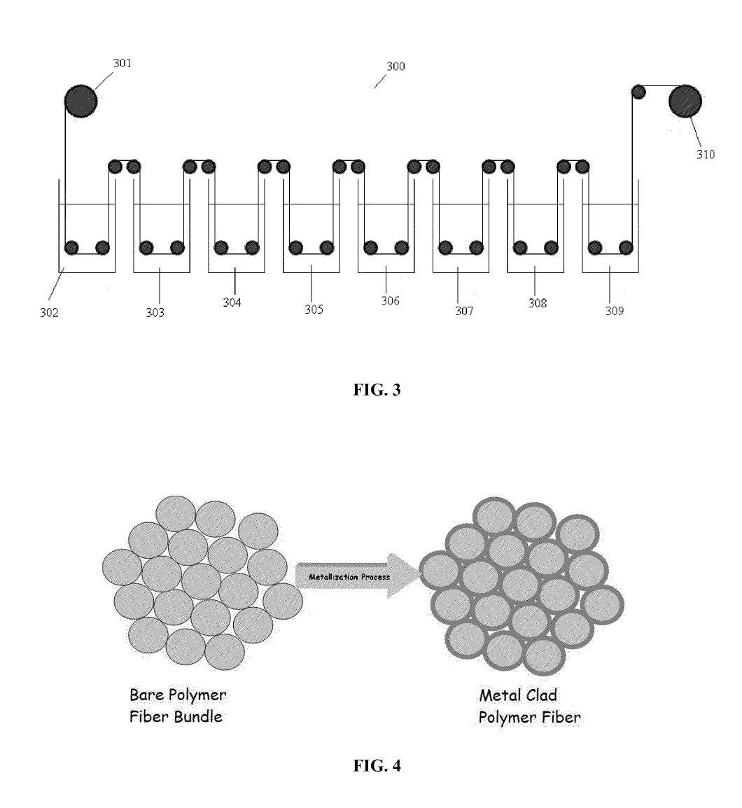

For purposes of illustrating one embodiment of the provided continuous process, reference to the schematic of FIG. 3 is made. Depicted therein is a continuous process 300, wherein melt-processable, thermotropic wholly aromatic liquid crystalline polymer fiber 301 is sequentially transported through an etching station 302 in which the fiber is contacted with alkaline solution and ultrasonic agitation (not labeled); through a water rinse station 303; through a catalyst seeding station 304 in which the fiber is contacted with one or more electroless plating catalysts; through a reducing station 305 in which the fiber is contacted with a reducing solution; through a water rinse station 306; through an electroless plating station 307 wherein one or more coatings of electroless metal are deposited onto the fiber; through a water rinse station 308; through an electroplating station 309 wherein one or more coatings of electroplated metal are deposited onto the one or more coatings of electroless metal, the sum of which produces a provided metal-plated fiber 310. In the continuous process 300, one or more optional special rollers (not labeled), tension control (for example, below 50 g), and combinations may be employed in at least the etching step. Tension control may also be achieved by adjusting fiber transfer speed between each bath.

### III. Metal-Plated Polymer Fibers Prepared by a Continuous Process

In various embodiments, provided are metal-plated melt processable wholly aromatic polyester liquid crystalline polymer fibers, as well as a continuous process for preparation of electrically conductive metal-coated fibers. Additionally provided are metal-plated polymer fibers consisting essentially of repeating units of (I) and (II):

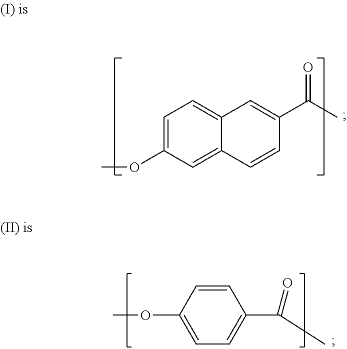

the metal-plated fiber prepared by a continuous process, comprising (a) etching the surface of the fiber by contacting it with alkaline solution in the presence of ultrasonic agitation, wherein the alkaline solution does not comprise surfactant or solubilizer; (b) seeding the etched surface of (a) with catalyst by contacting the fiber with one or more electroless plating catalysts selected from salts of silver, nickel, gold, platinum, osmium, palladium, and rhodium; (c) reducing the catalyst by contacting the fiber of (b) with a reducing solution; (d) electrolessly plating at least one coating of metal on the fiber of (c), the electroless-plated metal selected from nickel, copper, silver, and alloys thereof; and (e) optionally, electroplating at least one coating of metal on the fiber of (d), the electroplated metal selected from tin, nickel, copper, silver, gold, and alloys thereof. In some embodiments, at least one hydrogen of an aromatic ring of (I), (II), or both, may be substituted with an alkyl group, an alkoxy group, a halogen, or combinations thereof.

### IV. Polymeric Article Having Electromagnetic Interference Shielding Effectiveness

In some embodiments, a provided metal-plated fiber or other fiber prepared by the provided process may be adapted for use in EMI shielding. Accordingly, provided in some embodiments are polymeric articles having electromagnetic interference shielding effectiveness, comprising (a) a melt processable, thermotropic wholly aromatic liquid crystalline polymer fiber; (b) at least one coating of electroless-plated metal on the fiber of (a); and (c) optionally, at least one coating of electroplated metal on the fiber of (b); wherein the fiber of (b) or (c) is adapted to be woven or braided to provide a polymeric article having electromagnetic interference shielding effectiveness. In some embodiments, the electroless-plated metal is selected from nickel, copper, silver, and alloys thereof. One example is nickel/phosphorous alloy. In some embodiments, the electroplated metal is selected from tin, nickel, copper, silver, gold, and alloys thereof.

In various embodiments, the melt processable, thermotropic wholly aromatic liquid crystalline polymer fiber consisting essentially of repeating units of (I) and (II):

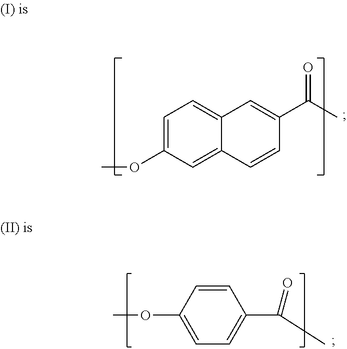

wherein at least one hydrogen of an aromatic ring of (I), (II), or both, may optionally be substituted with an alkyl group, an alkoxy group, a halogen, or combinations thereof.

In some embodiments, a provided polymeric article comprises a liquid crystalline polymer fiber with at least one coating of electroless-plated metal and at least one coating of electroplated metal.

In some embodiments, a provided polymeric article is adapted to provide a shielding effectiveness of from about 35 to about 80 decibels (db) across a frequency range of from about 0.1 to about 3000 MHz. Accordingly, shielding effectiveness may be from about 35-40 db, 40-45 db, 45-50 db, 50-55 db, 55-60 db, 60-65 db, 65-70 db, 70-75 db, 75-80 db, and combinations thereof. Shielding effectiveness may be across a frequency range of from about 0.1-200 MHz, 200-400 MHz, 400-600 MHz, 600-800 MHz, 800-1000 MHz, 1000-1200 MHz, 1200-1400 MHz, 1400-1600 MHz, 1600-1800 MHz, 1800-2000 MHz, 2000-2200 MHz, 2200-2400 MHz, 2400-2600 MHz, 2600-2800 MHz, 2800-3000 MHz, and combinations thereof.

### EXAMPLES

The described embodiments will be better understood by reference to the following examples which are offered by way of illustration and which one of skill in the art will recognize are not meant to be limiting.

### Example 1

The feasibility of the provided process was demonstrated on high-performance Vectran® fiber. An illustrative procedure for preparing metallized Vectran® fiber using a continuous wet chemical process may be summarized as:
1. Vectran® fiber is etched in a strong alkaline bath, such as potassium hydroxide or sodium hydroxide with a 30 to 60 wt % concentration, with a soaking duration of 10 to 300 seconds. The alkaline etching solution is preheated to 45° C. to 75° C. under ultrasonic agitation at 25 to 120 KHz.
2. The etched fiber is then thoroughly cleaned with plenty of deionized rinsed water for 30 to 240 seconds.
3. The wet fiber is then soaked in an acidic catalyst aqueous solution, such as palladium, silver or nickel ion solution with weight concentration of 0.01 to 0.5 g/l for 60 to 120 seconds. Surfactant such as sodium lauryl sulfate may also be added into the solution to facilitate the catalyst absorption to the fiber surface.
4. The absorbed palladium, silver or nickel ions are then reduced by an alkaline sodium borohydride, or dimethylamine borane reducing agent solution with a weight concentration of 0.001 to 0.015% for 15 to 60 seconds.
5. The catalyzed fiber is then neutralized in a dilute acid bath, such as hydrochloric or sulfuric acid, and subsequently rinsed thoroughly with deionized water for 30 to 240 seconds before being immersed in the electroless plating solution.
6. Electroless nickel, silver or copper can all be used for building up the conductive layer on the Vectran® fiber.
7. After the procedure 6, the resulting conductive fiber can then be electroplated with copper, nickel, silver and gold to enhance its electrical conductivity.
8. In general, careful and thorough rinsing with deionized water between baths is essential to control the plating quality for long term conductive fiber production.

### Example 2

A 200 Denier Vectran® HT yarn containing 40 monofilaments that are 23 micrometer in diameter, was used in this test. The Vectran yarn was first etched in a 45 wt % potassium hydroxide bath at 62° C. under 40 KHz ultrasonic agitation for 80 seconds. The yarn was then thoroughly rinsed using deionized water. Subsequently, the wet yarn was passed through a series of process baths, including 240 seconds each in palladium catalyst bath, sodium borohydride reduction bath, hydrochloric neutralizing bath and deionized water rinse bath. Nickel sulfate/sodium hypophosphite base electroless nickel was used to for the nickel undercoating coating on the treated yarn. The solution was made up by using 6 vol % of nickel sulfate, 15 vol % of sodium hypophosphite, and 79 Vol % of deionized water. The bath was operated in 190° F. at a PH value of 4.85 and constantly filtered through a 1 um filter. Generally, a soaking duration of two to three minutes will coat the yarn uniformly with a layer of phosphorus based electroless nickel of 0.5 to 0.75 micrometer. This electroless nickel-coated Vectran yarn exhibited an electrical resistance of ˜250 ohm/ft and was found conductive enough to facilitate the subsequent electroplating. Additional two minutes acid copper sulfate electroplating operated at a current of 3.75 amp resulted in a very highly conductive and uniform yarn with resistance of 2.06 ohm/ft.

### Example 3

A 200 Denier Vectran HT yarn containing 40 monofilaments that are 23 micrometer in diameter, was used in this test. The Vectran yarn was first etched in a 45 wt % potassium hydroxide bath at 62° C. under 40 KHz ultrasonic agitation for 80 seconds. The yarn was then thoroughly rinsed using deionized water. Subsequently, the wet yarn was passed through a series of process baths, including 240 seconds each in palladium catalyst bath, sodium borohydride reduction bath, hydrochloric neutralizing bath and deionized water rinse bath. Nickel sulfate/sodium hypophosphite base electroless nickel was used to for the nickel undercoating coating on the treated yarn. The solution was made up by using 6 vol % of nickel sulfate, 15 vol % of sodium hypophosphite, and 79 Vol % of deionized water. The bath was operated in 190° F. at a PH value of 4.85 and constantly filtered through a 1 um filter. Generally, a soaking duration of two to three minutes will coat the yarn uniformly with a layer of phosphorus based electroless nickel of 0.5 to 0.75 micrometer. This electroless nickel-coated Vectran yarn exhibited an electrical resistance of ˜250 ohm/ft and was found conductive enough to facilitate the subsequent electroplating. Additional two minutes acid copper sulfate electroplating operated at a current of 5.83 amp resulted in a very highly conductive and uniform yarn with electrical resistance of 1.23 ohm/ft.

### Example 4

200 Denier Vectran® HT was first etched by using concentrated sulfuric acid with solution weight concentration of 90 and then was treated as described in Example 1, except without KOH etching. No plating was observed on all the test fibers after electroless plating.

### Example 5

200 Denier Vectran® HT was first etched by using concentrated sulfuric acid with solution weight concentration of 98% and then was treated as described in Example 1, except without KOH etching. No plating was observed on all the test fibers after electroless plating.

This application should not be considered limited to the specific examples described herein, but rather should be understood to cover all aspects of the invention. Various modifications, equivalent processes, as well as numerous structures and devices to which the present invention may be applicable will be readily apparent to those of skill in the art. Those skilled in the art will understand that various changes may be made without departing from the scope of the invention, which is not to be considered limited to what is described in the specification.

What is claimed is:

1. An electrically conductive metal-plated liquid crystalline polymer fiber, comprising:
(a) a melt processable, thermotropic wholly aromatic liquid crystalline polymer fiber;
(b) at least one coating of electroless-plated metal on the fiber of (a), the electroless-plated metal selected from nickel, copper, silver, and alloys thereof; and
(c) optionally, at least one coating of electroplated metal on the fiber of (b), the electroplated metal selected from tin, nickel, copper, silver, gold, and alloys thereof.

2. A metal-plated fiber of claim 1, wherein the wholly aromatic liquid crystalline polymer fiber is a polyester consisting essentially of repeating units of (I) and (II): 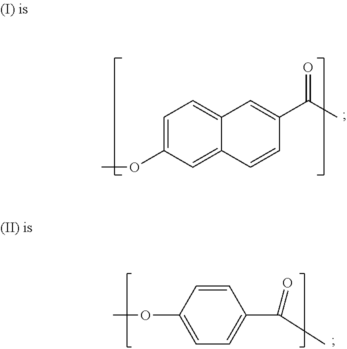
wherein at least one hydrogen of an aromatic ring of (I), (II), or both, may optionally be substituted with an alkyl group, an alkoxy group, a halogen, or combinations thereof.

3. A metal-plated fiber of claim 1, comprising at least one coating of electroless-plated metal and at least one coating of electroplated metal.

4. A metal-plated fiber of claim 1, comprising at least one coating of electroless-plated nickel or alloy thereof.

5. A metal-plated fiber of claim 4, wherein at least one coating of the electroless-plated metal is nickel/phosphorus alloy.

6. A metal-plated melt processable wholly aromatic polyester liquid crystalline polymer fiber consisting essentially of repeating units of (I) and (II): 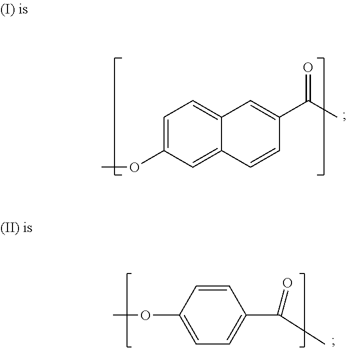
the metal-plated fiber comprising:
(a) at least one coating of electroless-plated metal on the fiber, the electroless-plated metal selected from nickel, copper, silver, and alloys thereof; and
(b) at least one coating of electroplated metal on the fiber of (a), the electroplated metal selected from tin, nickel, copper, silver, gold, and alloys thereof;
wherein at least one hydrogen of an aromatic ring of (I), (II), or both, may optionally be substituted with an alkyl group, an alkoxy group, a halogen, or combinations thereof.

7. A metal-plated fiber of claim 6, comprising at least one coating of electroless-plated nickel/phosphorus alloy.

8. A metal-plated fiber of claim 6, wherein the fiber is selected from monofilament and multi-filament yarns.

9. A continuous process for preparing metal-plated liquid crystalline polymer fibers, comprising:
(a) etching the surface of a melt processable, thermotropic wholly aromatic liquid crystalline polymer fiber by contacting it with alkaline solution in the presence of ultrasonic agitation, wherein the alkaline solution does not comprise surfactant or solubilizer;
(b) contacting the fiber of (a) with one or more electroless plating catalysts selected from salts of silver, nickel, gold, platinum, osmium, palladium, and rhodium;
(c) contacting the fiber of (b) with a reducing solution;
(d) electrolessly plating at least one coating of metal on the fiber of (c), the electroless-plated metal selected from nickel, copper, silver, and alloys thereof; and
(e) optionally, electroplating at least one coating of metal on the fiber of (d), the electroplated metal selected from tin, nickel, copper, silver, gold, and alloys thereof.

10. A continuous process according to claim 9, wherein the wholly aromatic liquid crystalline polymer fiber is a polyester consisting essentially of repeating units of (I) and (II): 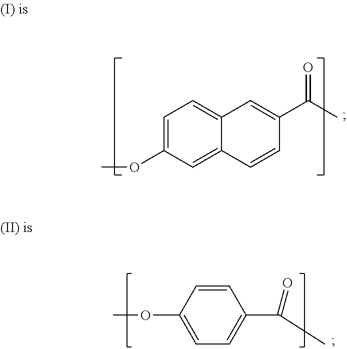
wherein at least one hydrogen of an aromatic ring of (I), (II), or both, may optionally be substituted with an alkyl group, an alkoxy group, a halogen, or combinations thereof.

11. A continuous process according to claim 9, wherein the alkaline solution comprises one or more bases selected from LiOH, NaOH, KOH, RbOH, CsOH, Ca(OH)₂, Sr(OH)₂, and Ba(OH)₂.

12. A continuous process according to claim 9, wherein the fiber is maintained under low tension.

13. A continuous process according to claim 9, wherein the electroless plating catalyst is palladium chloride.

14. A continuous process according to claim 9, wherein the reducing solution comprises sodium borohydride, dimethylamine borane, or both.

15. A continuous process according to claim 9, wherein at least one electroless-plated metal coated on the fiber is nickel/phosphorus alloy.

16. A continuous process for preparing metal-plated liquid crystalline polymer fibers, comprising:
(a) etching the surface of a melt processable wholly aromatic polyester liquid crystalline polymer fiber consisting essentially of repeating units of (I) and (II): 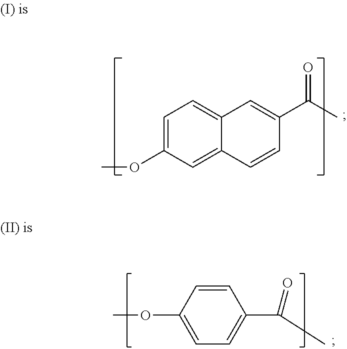
wherein at least one hydrogen of an aromatic ring of (I), (II), or both, may optionally be substituted with an alkyl group, an alkoxy group, a halogen, or combinations thereof;
wherein etching occurs by contacting the fiber with alkaline solution in the presence of ultrasonic agitation, the alkaline solution not comprising surfactant or solubilizer;
(b) contacting the fiber of (a) with one or more electroless plating catalysts selected from salts of silver, nickel, gold, platinum, osmium, palladium, and rhodium;
(c) contacting the fiber of (b) with a reducing solution;
(d) electrolessly plating at least one coating of metal on the fiber of (c), the electroless-plated metal selected from nickel, copper, silver, and alloys thereof; and
(e) electroplating at least one coating of metal on the fiber of (d), the electroplated metal selected from tin, nickel, copper, silver, gold, and alloys thereof.

17. A continuous process according to claim 16, wherein the fiber is maintained under low tension.

18. A continuous process according to claim 16, wherein the electroless plating catalyst is palladium chloride.

19. A continuous process according to claim 16, wherein the reducing solution comprises sodium borohydride, dimethylamine borane, or both.

20. A continuous process according to claim 16, wherein at least one electroless-plated metal coated on the fiber is nickel/phosphorus alloy.

21. A polymeric article having electromagnetic interference shielding effectiveness, comprising:
(a) a melt processable wholly aromatic polyester liquid crystalline polymer fiber consisting essentially of repeating units of (I) and (II): 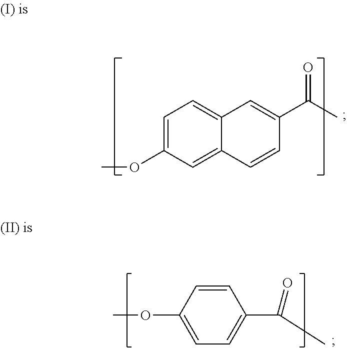
wherein at least one hydrogen of an aromatic ring of (I), (II), or both, may optionally be substituted with an alkyl group, an alkoxy group, a halogen, or combinations thereof;
(b) at least one coating of electroless-plated metal on the fiber of (a), the electroless-plated metal selected from nickel, copper, silver, and alloys thereof; and
(c) optionally, at least one coating of electroplated metal on the fiber of (b), the electroplated metal selected from tin, nickel, copper, silver, gold, and alloys thereof;
wherein the fiber of (b) or (c) is adapted to be woven or braided to provide a polymeric article having electromagnetic interference shielding effectiveness.

22. A polymeric article of claim 21, wherein the liquid crystalline polymer fiber comprises at least one coating of electroless-plated metal and at least one coating of electroplated metal.

23. A polymeric article of claim 21, wherein the liquid crystalline polymer fiber comprises at least one coating of electroless-plated nickel or alloy thereof.

24. A polymeric article of claim 23, wherein at least one coating of the electroless-plated metal is nickel/phosphorus alloy.

25. A polymeric article of claim 21 adapted to provide a shielding effectiveness of 35 to 80 decibels across a frequency range of 0.1 to 3000 MHz.

26. A metal-plated melt processable wholly aromatic polyester liquid crystalline polymer fiber consisting essentially of repeating units of (I) and (II): 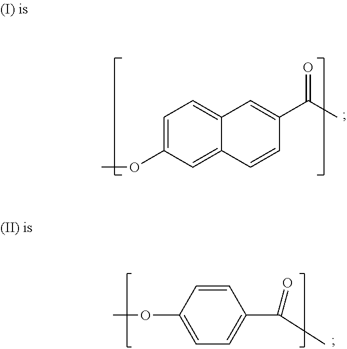
the metal-plated fiber prepared by a continuous process, comprising:
(a) etching the surface of the fiber by contacting it with alkaline solution in the presence of ultrasonic agitation, wherein the alkaline solution does not comprise surfactant or solubilizer;
(b) seeding the etched surface of (a) with catalyst by contacting the fiber with one or more electroless plating catalysts selected from salts of silver, nickel, gold, platinum, osmium, palladium, and rhodium;
(c) reducing the catalyst by contacting the fiber of (b) with a reducing solution;
(d) electrolessly plating at least one coating of metal on the fiber of (c), the electroless-plated metal selected from nickel, copper, silver, and alloys thereof; and
(e) optionally, electroplating at least one coating of metal on the fiber of (d), the electroplated metal selected from tin, nickel, copper, silver, gold, and alloys thereof;
wherein at least one hydrogen of an aromatic ring of I, II, or both, may optionally be substituted with an alkyl group, an alkoxy group, a halogen, or combinations thereof.

27. A polymeric article having electromagnetic interference shielding effectiveness, comprising:
(I) a metal-plated melt processable wholly aromatic polyester liquid crystalline polymer fiber consisting essentially of repeating units of (I) and (II): 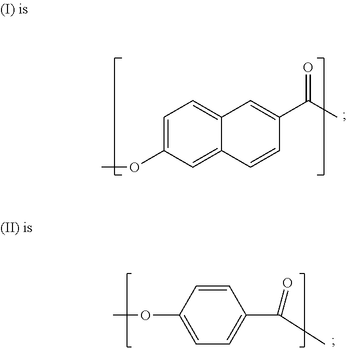
wherein at least one hydrogen of an aromatic ring of (I), (II), or both, may optionally be substituted with an alkyl group, an alkoxy group, a halogen, or combinations thereof, the metal-plated fiber prepared by a continuous process, comprising:
(a) etching the surface of the fiber by contacting it with alkaline solution in the presence of ultrasonic agitation, wherein the alkaline solution does not comprise surfactant or solubilizer;
(b) seeding the etched surface of (a) with catalyst by contacting the fiber with one or more electroless plating catalysts selected from salts of silver, nickel, gold, platinum, osmium, palladium, and rhodium;
(c) reducing the catalyst by contacting the fiber of (b) with a reducing solution;
(d) electrolessly plating at least one coating of metal on the fiber of (c), the electroless-plated metal selected from nickel, copper, silver, and alloys thereof; and
(e) optionally, electroplating at least one coating of metal on the fiber of (d), the electroplated metal selected from tin, nickel, copper, silver, gold, and alloys thereof;
wherein the metal-plated melt processable wholly aromatic polyester liquid crystalline polymer fiber is adapted to be woven or braided to provide a polymeric article having electromagnetic interference shielding effectiveness of 35 to 80 decibels across a frequency range of 0.1 to 3000 MHz.
